(19) United States
(12) Patent Application Publication
(10) Pub. No.: US 2018/0295126 A1
(43) Pub. Date: Oct. 11, 2018

(54) DYNAMIC COMPUTING RESOURCE ACCESS AUTHORIZATION

(71) Applicant: CONJUR, INC., Waltham, MA (US)

(72) Inventor: Kevin GILPIN, Weston, MA (US)

(21) Appl. No.: 15/522,350

(22) PCT Filed: Sep. 22, 2016
(86) PCT No.: PCT/US2016/053004

§ 371 Date: Apr. 27, 2017

Related U.S. Application Data
(60) Provisional application No. 62/221,819, filed on Sep. 22, 2015.

(51) Int. Cl. H04L 29/06

(52) U.S. Cl. CPC H04L 63/0853; H04L 63/102

(57) ABSTRACT

Dynamic computing resource access authorization is utilized to manage access to computing resources in a computing environment. A user obtains a digital credential such as a token from an access authority and includes the digital credential in an access request transmitted to a computing resource. The computing resource includes a protective gatekeeper access layer that receives the user request and transmits a user confirmation request to the access authority. The user confirmation request includes the digital credential, which can be used by the access authority to link the users identity to a permission set or the like. The access authority then transmits a status confirmation to the computing resources access layer. The status confirmation may approve or deny the users access request and/or may include permission(s) used by the access layer in allowing or denying the users access request.

### RELATED APPLICATIONS

This application hereby claims the benefit of and priority to U.S. Provisional Patent Application 62/221,819, entitled “DYNAMIC TRAFFIC AUTHORIZATION FOR ACCESS TO SERVICES,” filed 22 Sep. 2015, and which is hereby incorporated by reference in its entirety.

### TECHNICAL FIELD

Aspects of the disclosure are related to the field of access control in computing environments and, in particular, dynamically authorizing access to resources in a computing environment.

### TECHNICAL BACKGROUND

Cloud computing systems and the like can use virtualized computer systems and other computing resources to provide flexible computing to end users. Cloud computing systems allow for users spread over a variety of geographic locations to access resources of such virtualized and other computer systems, such as databases, applications, web content, or other digital data, services, or content. Cloud Service Providers (CSPs) such as Amazon, Google, Rackspace, and OpenStack deploy physical hardware such as servers, network infrastructure, and connectivity for the cloud computing systems to host digital products and services from various remote locations. Cloud service customers can employ the resources provided by the various CSPs without having to purchase and maintain physical equipment.

Access to computing resources in various computing environments (e.g., cloud resources of the various CSPs) frequently is managed through permissions. These permissions can include usernames and passwords, as well as other credentialing information. However, in cloud computing environments, access control beyond initial user authorization is limited. The current access control systems lack the ability to manage access dynamically and to do so without overburdening the computing resources with additional processes related to access control.

### OVERVIEW

Non-limiting examples described herein provide various systems, apparatuses, methods, and software that provide enhancements for managing resources in a computing environment by implementing dynamic computing resource access authorization. In one implementation, a method of controlling computing resource access in a computing environment includes an authentication system transmitting a token to a user in response to receiving a token request from that user. The authentication system receives a user confirmation request from a computing resource that has received an access request from the user, where the user's access request may include the token (e.g., in an HTTP header). The authentication system transmits a status confirmation to the computing resource in response to the user confirmation request. The status confirmation may indicate approval or denial of the user's access to the computing resource and/or may provide the computing resource with a permission set defining access rights for the user based on the token. Receipt and transmission of requests and other communications may be performed by an access layer associated with the computing resource, where the access layer protects the computing resource from unauthorized access.

In another implementation, a management system for controlling computing resource access in a computing environment includes one or more computer readable media. The system further includes processing instructions stored on the one or more computer readable media that, when executed by a processing system, direct the processing system to transmit a token to a user in response to that user's request for a token (and, in some implementations, in addition to and/or as part of an authentication process for authenticating the user). Thereafter, when a user confirmation request including the token is received by the management system, the management system can identify the user associated with the token and any permission(s) associated with that user. A status confirmation from the management system to the computing resource can confirm or deny the user's requested access to the computing resource and/or can provide the computing resource with a permission set for that user. In the various implementations, the user's permission(s) and/or the status confirmation may be cached for future use. Moreover, tokens used in various implementations may be time-limited so that use of the token expires after a preselected period of time.

In one other implementation a computing resource receives a user request that includes a token (e.g., a digital credential). The computing resource includes the token in a user confirmation request to an authentication service and/or management system that responds by transmitting a status confirmation to the computing resource that defines whether or not the user request should be processed by the computing resource. The computing resource can include an access layer that protects the computing resource from unauthorized access, and receives the first user access request, transmits the user confirmation request and receives the status confirmation.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a computing environment implementing dynamic computing resource access authorization according to one implementation.

FIG. 2 illustrates a method of operation of a computing environment implementing dynamic computing resource access authorization according to one implementation.

FIG. 3 illustrates a method of operation of a computing environment implementing dynamic computing resource access authorization according to one implementation.

FIG. 4 illustrates a computing system in one or more implementations of dynamic computing resource access authorization.

### DESCRIPTION

Access control in a computing environment regulates access to one or more resources in the computing environment and is a key facility to providing the isolation that makes cloud computing possible. Access to cloud resources can be managed through permissions that enable operations on resources (e.g., by human and computer-controlled actors and other users). As the numbers of users and resources increase, permission management complexity likewise increases.

Access control typically is thought of with permanence; an actor or other user is assigned certain permissions (e.g., as a permission set) with regard to various resources and is thus granted continuous and ongoing access to operate on those resources (e.g., including but not limited to reading data, controlling operations, and/or modifying information).

Dynamic computing resource access authorization implementations include wrapping a computing resource (e.g., a service) with an access control layer so that an access control policy (e.g., an externally controllable, configurable, and/or auditable access control policy) can dynamically enable, limit and/or disable a user's access to the controlled computing resource. When a user transmits a request to access a computing resource, that call is intercepted by or rerouted to a dynamic traffic authorization (DTA) layer of the computing resource. The DTA layer communicates with an access authority (e.g., an authenticating service implemented using a centralized server or repository of role-based access control (RBAC), permissions, policies and the like) to find out whether the requesting user is allowed to access the computing resource as requested (e.g., in some implementations, defining and/or limiting the way(s) in which the user is allowed to interact with the called computing resource). If the user request is approved (e.g., by the access authority or after the access layer obtains the request user's permission set), the DTA access layer allows the call to pass on to the computing resource. If the call is not allowed, the DTA access layer does not pass the call on to the computing resource.

In some implementations addressing Hypertext Transfer Protocol (HTTP) communication protection, the HTTP headers are used to wrap a user call with a permission layer. In some implementations for HTTP representational state transfer (REST) services, policy rules can be implemented and be based on the HTTP endpoints (e.g., /api/info, whether exact matching or regular expression matching), or the HTTP method (e.g., GET or POST), or other properties of the call being made to the REST service.

In other implementations non-HTTP communications can be protected with various mechanisms. A generic stunnel approach can handle any arbitrary Transmission Control Protocol (TCP) and user datagram protocol (UDP) traffic between two hosts (host with any port number) and services (host+specific port number(s)). A structured approach can be implemented for well-defined remote procedure call (RPC) protocols, such as SunRPC, CORBA, Java JMI, .NET Remoting, and others wherein dynamic computing resource access authorization is configured to accommodate the specifics of those protocols and, optionally, which functions are being called and the type of operation being performed.

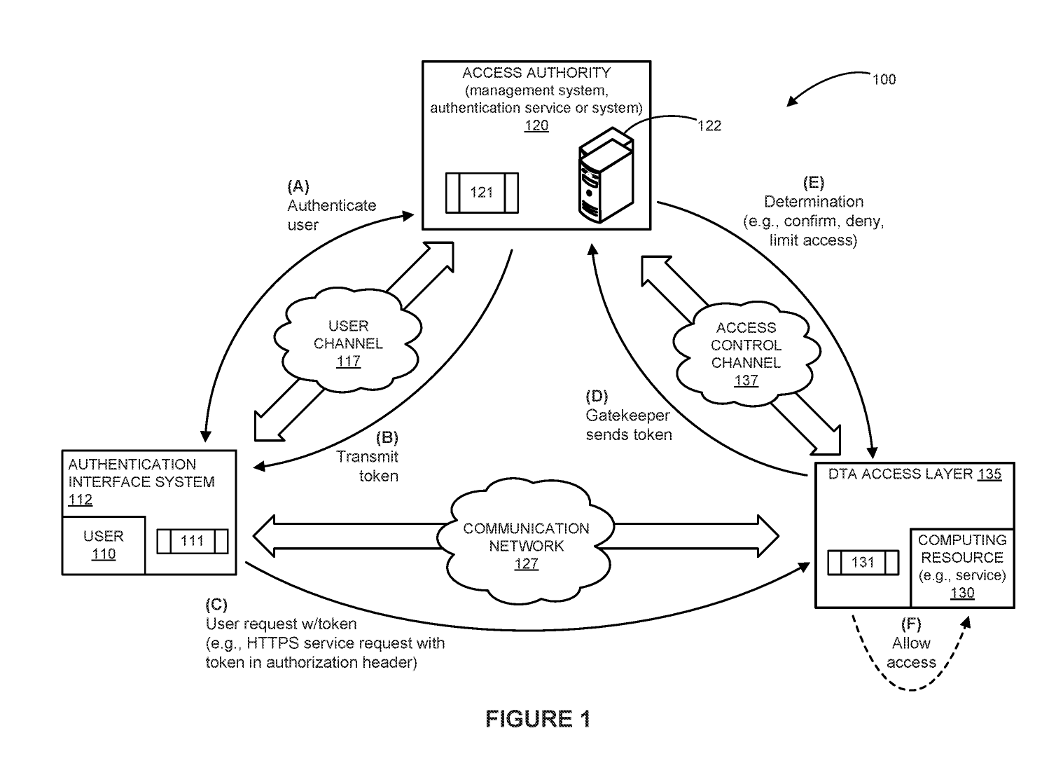

Referring to FIG. 1, a computing environment 100 implements dynamic computing resource access authorization to authorize users to access computing resources. Non-limiting exemplary operation of dynamic computing resource access authorization in computing environment 100 is illustrated in FIG. 1, the order of which is designated by the reference letters (A) through (E), but note that the steps could be performed in any order for any operation described herein. A user 110 can be a person, process, service, computer device or system, virtual machine and/or any other entity. In some implementations an authentication module 112 may be part of user 110 to assist in authenticating user 110 with access authority 120 and for updating and other operations. To reduce or eliminate latency, tokens can be prefetched so that a token is already available when required by user 110. Communications between user 110 and access authority 120 can be transmitted using any appropriate user channel 117.

User 110 sends a call (step (C)) to computing resource 130, for example using a communication network 127 (e.g., the Internet). In some implementations the call can be an HTTPS request with the user's token in the HTTPS request's authorization header. Before being delivered to the requested computing resource, such calls are evaluated by a DTA access layer 135 that acts as a gatekeeper for and wraps computing resource 130. Access layer 135 receives user 110's call and transmits an authorization request (step (D)) that includes the user token to access authority 120, for example using a communication channel 137 (while separate channels/networks are shown in FIG. 1, any suitable way of communicating between the various elements may be used, including all of the communications being sent using the same communication network, such as the Internet or a private network). Access authority 120 can include one or more servers 122 (and/or repositories, systems, etc.) that process such authorization requests to determine a user's access rights based on the token presented in the authorization request. In some implementations a user's access profile can be defined administratively and provided to an access authority, which permits centralized access control and updating. With a single (or small number) of access authorities operating in a given computing environment, updating users' access profiles, permissions, etc. can be updated quickly and easily with minimal overhead.

An authentication service in access authority 120 can verify a received token to obtain the user's identity and check whether the user identity linked to the token has the necessary privilege on the gatekeeper resource (i.e., does the token identify a user that possesses (is linked to) the necessary permission(s) to access and perform the requested operation on the subject computing resource). Access authority 120 can then respond (step (E)) to the request from access layer 135. In some implementations an authentication service in access authority 120 sends an HTTP status code indicating whether or not the user's call should be allowed (e.g., a status confirmation comprising a permission set defining the user's permission(s) with regard to the requested computing resource). When a user's request is cleared by access authority 120, the request is passed by access layer 135 to computing resource 130 for processing and/or other action. Any response from computing resource 130 can then by transmitted back to user 110.

In some implementations the access layer 135 can cache the status code so that verification of user 110 does not have to be performed each time a call is sent from user 110 to computing resource 130. However, if it is likely that changes might be made to a user's permissions or that they may be revoked, access layer 135 can perform its authentication process (steps (D) and (E)) for each access attempt by user 110. Moreover, the status code or other status confirmation (e.g., a verification) sent by access authority 120 may be timestamped or have other temporal indicia that limit the time period during which a given cached approval is valid for a given user, token, etc.

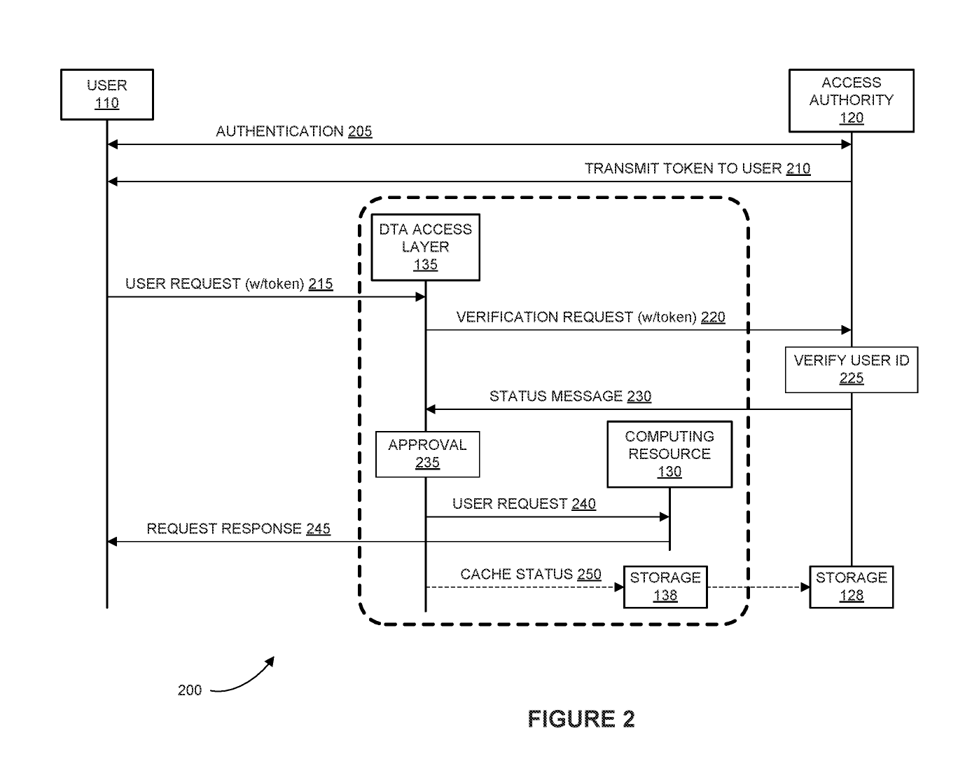

FIG. 2 is a method flow diagram illustrating aspects of one or more methods of operation 200 of an access control system. In such exemplary methods, a user can obtain a digital credential (e.g., a token), include that digital credential in accessing computing resources, and permit verification of the user's permissions and/or access rights prior to granting user access to the protected computing resources. In FIG. 2, the user 110, access authority 120, computing resource 130 and its associated protecting access layer 135 of FIG. 1 are used to help illustrate these methods, though these components are in no way limiting in defining dynamic computing resource access authorization.

Initially user 110 is authenticated (operation 205) and either immediately or at a later time receives a digital credential such as a token transmitted to user 110 by access authority 120 (operation 210). User 110 then submits a user request (operation 215) requiring access to computing resource 130. The request is intercepted by access layer 135, which in turn transmits a verification request (which can include the submitted user token) to access authority 120 (operation 220). Access authority 135 processes the verification request to determine the identity of the user associated with the submitted token (operation 225), which can be used to verify the identity of the relevant user.

Once the identity of the user associated with the submitted token has been verified by access authority 120, a status message (e.g., a status confirmation) can be transmitted to access layer 135 (operation 230). That message can confirm the user's identity and permission to access computing resource 130, indicate that the submitted token is not associated with the submitting user (user 110 in this example), confirm the user's identity but deny access to the requested computing resource, and/or provide other relevant information to the access layer 135 for current or future use. In the non-limiting example of FIG. 2, user 110's identity is confirmed, as is that user's permission to access computing resource 130 (operation 235). Based on this approval, access layer 135 forwards the user request to computing resource 130 for processing (operation 240). After computing resource 130 has completed processing of the user request, a request response can be sent to user 110 (operation 245).

In some implementations relevant information about the transaction can be stored for future reference, use, auditing and/or other purposes. For example, the user identity associated with the submitted token can be stored by access layer 135 (operation 250) for future use (e.g., in an access layer storage unit 138). The shelf life of such data may be limited to mitigate the risk of use of outdated access control and/or permissions. Moreover, other data about the user request and other transactions in such methods 200 can be stored by access layer in its storage unit 138. The same and/or other data may likewise be transmitted to and stored by the access authority 120 (e.g., in an access authority storage unit 128).

In a situation where the user's identity is not confirmed by access authority 120, or where user 110 requests access and interaction with computing resource 130 that is beyond user 110's permissions, appropriate action may be taken for security purposes. Moreover, an auditing or similar protocol may be in place to record and reference such denied requests to generate a log or other record of transactions between users, computing resources and/or access authorities.

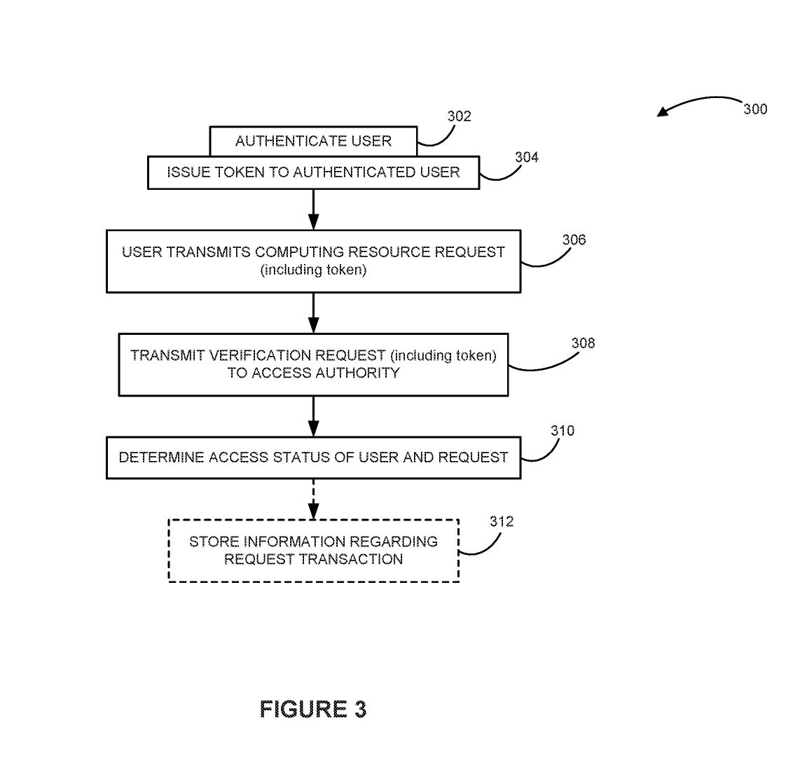

FIG. 3 illustrates one or more non-limiting examples of a method 300 of operation for dynamic computing resource access authorization. A user is authenticated by or on behalf of an access authority (302) and receives a digital credential, such as a token (304). Subsequently, the user transmits an access request (306) to a computing resource. An access layer intercepts the access request and transmits a verification request to the access authority (308), where the verification request can include the token and any other relevant information about the user's computing resource access request. The access authority can then determine (310) whether the submitted token matches the identity of the user and, further, whether the token represents permissions that allow the user access request to proceed to the requested computing resource. Regardless of the determination with regard to the user's request being submitted to the requested computing resource, an appropriate record can be made by storing information about the requested transaction (312).

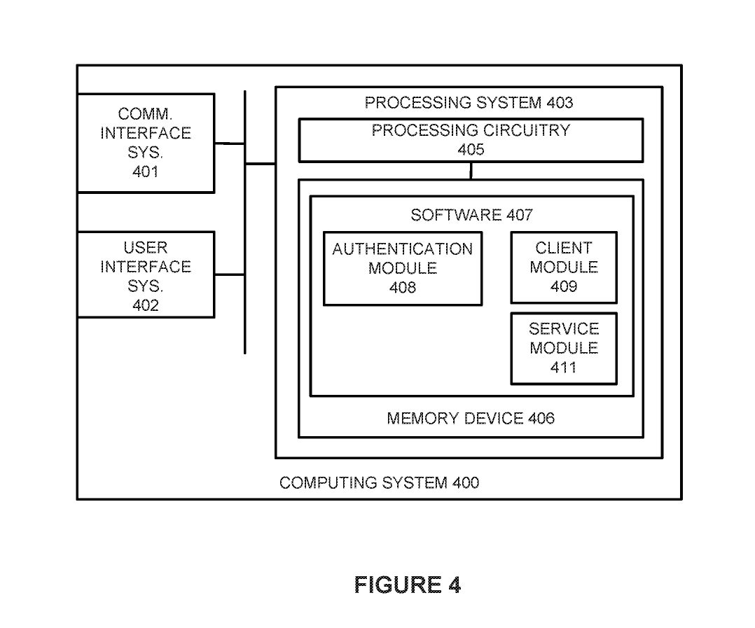

FIG. 4 illustrates a computing system 400 to operate within a dynamic computing resource access authorization system according to one or more implementations. Computing system 400 is representative of any computing system or systems with which the various operational architectures, processes, scenarios, and sequences disclosed herein for an authorization system may be implemented. Computing system 400 may be an example of authentication module 112, access authority 120 and/or access layer 135 of FIGS. 1 and/or 2, although other examples may exist. Computing system 400 may comprise one or more server computing systems, desktop computing systems, routers, gateways, switches, and other similar computing elements, including combinations thereof. Computing system 400 comprises communication interface system 401, user interface system 402, and processing system 403. Processing system 403 is linked to communication interface system 401 and user interface system 402. Processing system 403 includes processing circuitry 405 and memory device 406 that stores operating software 407. Memory device 406 may also store information concerning user computing resource access requests, as well as other data utilized in some implementations.

Communication interface system 401 comprises components that communicate over communication links, such as network cards, ports, radio frequency (RF) transceivers, processing circuitry and software, or some other communication devices. Communication interface system 401 may be configured to communicate over metallic, wireless, or optical links Communication interface system 401 may be configured to use Time Division Multiplex (TDM), Internet Protocol (IP), Ethernet, optical networking, wireless protocols, communication signaling, or some other communication format—including combinations thereof.

User interface system 402 comprises components that permit interaction with a user (e.g., an administrator) to receive inputs and to present media and/or information (e.g., updating user permissions for access authority 120). User interface system 402 may include a speaker, microphone, buttons, lights, display screen, touch screen, touch pad, scroll wheel, communication port, or some other user input/output apparatus—including combinations thereof. One or more components of user interface system 402 may be omitted in some non-limiting examples. The entire user interface system 402 may be omitted in some non-limiting examples.

Processing circuitry 405 comprises microprocessor and other circuitry that retrieves and executes operating software 407 from memory device 406 (including, in some non-limiting examples, one or more of software 111, 121, 131 of FIG. 1). Memory device 406 comprises a non-transitory storage medium, such as a disk drive, flash drive, data storage circuitry, or some other memory apparatus. Processing circuitry 405 is typically mounted on one or more circuit boards that may also hold memory device 406 and at least portions of communication interface system 401 and user interface system 402. Operating software 407 comprises computer programs, firmware, or some other form of machine-readable processing instructions (e.g., a computer readable storage medium having instructions stored thereon that, when executed by the one or more processors, causes the management system to operate as described herein).

Operating software 407 includes identification module 408 and generate module 409, although any number of software modules may provide the same operation. Operating software 407 may further include an operating systems, virtual machine, containers, such as Docker containers, utilities, drivers, network interfaces, applications, or some other type of software. When executed by processing circuitry 405, operating software 407 directs processing system 403 to operate computing system 400 as described herein.

In particular, when computing system 400 operates as or as part of an access authority arbitrating communications between users and computing resources, operating software 407 can include an authentication module 408 (e.g., operating as software 121 in FIG. 1) that authenticates users, dispenses tokens to authenticated users, processes and responds to user and/or token identification requests from one or more access layers associated with computing resources, maintains and updates permissions and other information and data relevant to performing as described herein. Likewise, when computing system 400 operates as or as part of a user's authentication interface system, operating software 407 can include an authentication module 408 (e.g., operating as software 111 in FIG. 1) that authenticates its user with an access authority, receives tokens dispensed by one or more access authorities, assists in processing outgoing computing resource requests to ensure that an appropriate token and/or other identification information is included to assist in access control procedures, and maintains and updates permissions, tokens and other information and data relevant to performing as described herein. Similarly, when computing system 400 operates as or as part of a computing resource protected by dynamic computing resource access authorization, operating software 407 can include an authentication module 408 (e.g., operating as software 131 in FIG. 1) that establishes and operates as an access layer by receiving user computing resource access requests, communicates with one or more access authorities to verify user identities and permissions, permitting and prohibiting access to an associated computing resource as described herein, and maintains and updates records, permissions, tokens and other information and data relevant to performing as described herein.

Software 407 may also include a client module 409 that directs processing system 403 to provide client operations described herein. Similarly, a service module 411 can direct processing system 403 to provide service operations, including gatekeeper operations, described herein.

To perform as described in the noted capacities, computing system 400 may communicate with one or more agents that provide reports of the operations within the environment, and may be manually provided with information by an administrator or the like, or may receive operational information in any other manner, including combinations thereof.

The functional block diagrams, operational scenarios and sequences, and flow diagrams provided in the Figures are representative of exemplary systems, environments, and methodologies for performing novel aspects of the disclosure. For purposes of simplicity of explanation, methods included herein may be in the form of a functional diagram, operational scenario or sequence, or flow diagram, and may be described as a series of acts. It is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1-20. (canceled)

21. A non-transitory computer readable medium including instructions that, when executed by at least one processor, cause the at least one processor to perform operations for securing access to a target network resource in a cloud computing environment, the operations comprising:
authenticating an identity in a cloud computing environment;
providing, by an access authority and based on the authentication of the identity, a token to the identity;
receiving, at the access authority and from an access layer resource, the token that was transmitted to the identity, the token having been included by the identity in an access request to a target resource in the cloud computing environment; and
determining, based on the received token, whether to permit the identity to access the target resource in the cloud computing environment.

22. The non-transitory computer readable medium of claim 21, wherein the access request is an HTTP request and the token is included in a header field of the HTTP request.

23. The non-transitory computer readable medium of claim 21, wherein the access request is intercepted by the access layer resource before reaching the target resource.

24. The non-transitory computer readable medium of claim 21, wherein the access layer resource is integrated into the target resource.

25. The non-transitory computer readable medium of claim 21, wherein the access layer resource is separate from the target resource.

26. The non-transitory computer readable medium of claim 21, wherein the operations further comprise maintaining an access profile for the identity, the access profile specifying a right of the identity to access the target resource.

27. The non-transitory computer readable medium of claim 26, wherein the token is associated with the access profile.

28. The non-transitory computer readable medium of claim 21, wherein the operations further comprise verifying the received token.

29. The non-transitory computer readable medium of claim 21, wherein the operations further comprise, if the identity is permitted to access the target resource, passing the access request to the target resource.

30. The non-transitory computer readable medium of claim 21, wherein the token has a defined life span during which it is operative.

31. A computer-implemented method for securing access to a target network resource in a cloud computing environment, the method comprising:
authenticating an identity in a cloud computing environment;
providing, by an access authority and based on the authentication of the identity, a token to the identity;
receiving, at the access authority and from an access layer resource, the token that was transmitted to the identity, the token having been included by the identity in an access request to a target resource in the cloud computing environment; and
determining, based on the received token, whether to permit the identity to access the target resource in the cloud computing environment.

32. The computer-implemented method of claim 31, further comprising assigning an HTTP status code based on whether the identity is permitted to access the target resource.

33. The computer-implemented method of claim 32, further comprising caching the HTTP status code for future requests by the identity using the token.

34. The computer-implemented method of claim 31, further comprising storing information regarding the identity and the token for auditing purposes.

35. The computer-implemented method of claim 31, wherein the token has a defined life span during which it is operative.

36. The computer-implemented method of claim 31, wherein receiving the token includes receiving an authorization request from the access layer resource that includes the token.

37. The computer-implemented method of claim 36, further comprising responding to the authorization request from the access layer resource.

38. The computer-implemented method of claim 37, wherein the response to the authorization request includes an HTTP status code indicating whether or not the access request by the identity should be allowed.

39. The computer-implemented method of claim 37, wherein the response to the authorization request includes an HTTP status code indicating whether or not the token is valid.

40. The computer-implemented method of claim 31, further comprising setting a temporal limitation on a permission for the identity to access the target resource in the cloud computing environment.
